(19) United States
(12) Patent Application Publication
(10) Pub. No.: US 2007/0155213 A1
(43) Pub. Date: Jul. 5, 2007

(54) Flat circuit connector with pivoted actuator

(76) Inventor: Hee-Seok Shin, Kyunggi-do (KR)

Correspondence Address: Stephen Z Weiss;Molex Incorporated, 2222 Wellington Court, Lisle, IL, 60532, US

(21) Appl. No.: 10/569,840

(22) PCT Filed: Aug. 25, 2004
(86) PCT No.: PCT/US04/27555

§ 371 Date: Oct. 23, 2006

(30) Foreign Application Priority Data
Aug. 27, 2003 (KR) 10-2003-0059453

(51) Int. Cl. H01R 13/15

(52) U.S. Cl. 439/260

(57) ABSTRACT

An electrical connector (30) is provided for terminating a flat electrical circuit (32). The connector includes a di-electric housing (34) having a front opening (36) for receiving an end of the flat circuit. A plurality of terminals (38) are mounted on the housing in a side-by-side array and spaced laterally along the opening. An elongated actuator (40) is movably mounted on the housing for movement between an open position allowing the flat circuit to be inserted into the opening and a closed position. An elongated pressing plate (40a) extends along a front of the actuator for biasing the flat circuit against the terminals when the actuator is in its closed position. An elongated pivot shaft (40b) extends along a rear of the actuator and is spaced from the pressing plate for pivoting the actuator between the open and closed positions. A plurality of supports (54) are spaced longitudinally of the actuator and are joined between the elongated pressing plate and the elongated pivot shaft.

### FIELD OF THE INVENTION

This invention generally relates to the art of electrical connectors and, particularly, to a connector for terminating a flat circuit, such as a flat flexible circuit, a flexible printed circuit or other flat electrical cable.

### BACKGROUND OF THE INVENTION

A wide variety of electrical connectors have been designed for terminating flat cables or circuits. A typical connector for flat circuits includes a dielectric housing molded of plastic material, for instance. The housing has an elongated opening or slot for receiving an end of the flat circuit which has generally parallel, laterally spaced conductors exposed across the end. A plurality of terminals are mounted in the housing and are spaced laterally along the slot, with contact portions of the terminals engageable with the laterally spaced conductors of the flat circuit. An actuator often is movably mounted on the housing for movement between a first position whereat the flat circuit is freely insertable into the slot and a second position whereat the actuator clamps the circuit in the housing and biases the circuit against the contact portions of the terminals.

FIGS. 7 and 8 herein show a prior art flat circuit connector of the character described above. The connector includes a housing, generally designated 20, having a plurality of terminals, generally designated 22, mounted in the housing from the rear thereof. The housing is mounted on a printed circuit board (not shown) and is fabricated of dielectric plastic material. The housing has a slot 20a at the front thereof for receiving an end of a flat circuit in a circuit insertion direction as indicated by arrow “B”. The housing includes a rear portion 24b having a plurality of pairs of terminal-receiving passages 20c into which terminals 22 are mounted. Finally, the housing is elongated and includes a pair of walls or fixing arms 20d having fixing grooves 20e formed on the insides thereof. An elongated actuator, generally designated 24, is pivotally mounted on housing 20 by means of a pair of fixing protrusions 24a having pivot bosses 24b at opposite ends of the housing. The fixing protrusions are rotatably mounted in fixing grooves 20e formed inside arms 20d. A pair of locking protrusions 24c are formed at opposite ends of the elongated actuator at the front thereof. The locking protrusions are hooked against the front of the housing when the actuator is in a closed position as shown in FIG. 16.

A pair of substantially enclosed fitting nails 26 are mounted over generally inverted T-shaped mounting portions 20f of the housing in the direction of arrows “B”. The fitting nails are fabricated of metal material and are soldered to mounting pads on the printed circuit board to secure the connector to the board.

Actuator 24 is rotated 90° from its closed position shown in FIGS. 7 and 8, to stand upright, and its rear end is inserted between fixing arms 20d of the housing. Fixing protrusions 24a are respectfully inserted into fixing grooves 20e inside arms 20d to fixed the actuator to the housing. This defines the open position of the actuator. While the actuator is in this open position, the end of the flat circuit is inserted into slot 20a in the direction of arrow “A”. The actuator then is rotated about pivot bosses 24b to the closed position shown in FIGS. 7 and 8 to bias appropriate contacts on the bottom of the flat circuit against terminals 22.

The prior art connector described above has problems in that the actuator is not solidly pivoted to the housing except for the pivot bosses 24c at the very extreme opposite ends of the actuator. The present invention is directed to solving these problems.

### SUMMARY OF THE INVENTION

An object, therefore, of the invention is to provide a new and improved electrical connector for terminating a flat electrical circuit.

In the exemplary embodiment of the invention, the connector includes a dielectric housing having a front opening for receiving an end of the flat circuit. A plurality of terminals are mounted on the housing in a side-by-side array and spaced laterally along the opening. An elongated actuator is movably mounted on the housing for movement between an open position allowing the flat circuit to be inserted into the opening and a closed position. An elongated pressing plate extends along a front of the actuator for biasing the flat circuit against the terminals when the actuator is in its closed position. An elongated pivot shaft extends along a rear of the actuator and is spaced from the pressing plate for pivoting the actuator between the open and closed positions. A plurality of supports are spaced longitudinally of the actuator and are joined between the elongated pressing plate and the elongated pivot shaft.

According to one aspect of the invention, the terminals include portions located between the spaced supports longitudinally of the actuator. In the exemplary embodiment, at least some of the terminals comprise pivot terminals and have pivot arms for engaging the pivot shaft of the actuator to facilitate pivotal movement of the actuator. The pivot arms are located between the spaced supports.

According to another aspect of the invention, when the actuator is in its closed position, the pressing plate is forwardly of a vertical plane passing through the pivot shaft. The actuator includes a pressure portion rearwardly of the plane for performing a dual function of (1) pressing the flat circuit against the terminal, and (2) providing an over-center means to resist rotation of the actuator away from its closed position.

According to other features of the invention, the actuator includes longitudinally outwardly projecting cams at opposite ends thereof and rotatably positioned in cam recesses in the housing. The actuator further includes longitudinally outwardly projecting locking protrusions at opposite ends thereof and positionable in locking grooves at opposite ends of the housing when the actuator is in its closed position.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a flat circuit connector according to the invention, with the actuator in its closed position;

FIG. 2 is an exploded perspective view of the connector;

FIG. 3 is a perspective view of the actuator isolated from the remainder of the connector;

FIG. 4 is an enlarged front-to-rear section through the connector with the actuator in its open position;

FIG. 5 is a view similar to that of FIG. 4, with the actuator in its closed position;

FIGS. 6A-6D are fragmented perspective views, partially in section, of one end of the connector, showing sequential movement of the actuator from its open to its closed positions; and

FIGS. 7 and 8 are views of the prior art connector described in the Background, above.

### DETAILED DESCRIPTION OF THE PREFERRED EMBODIMENT

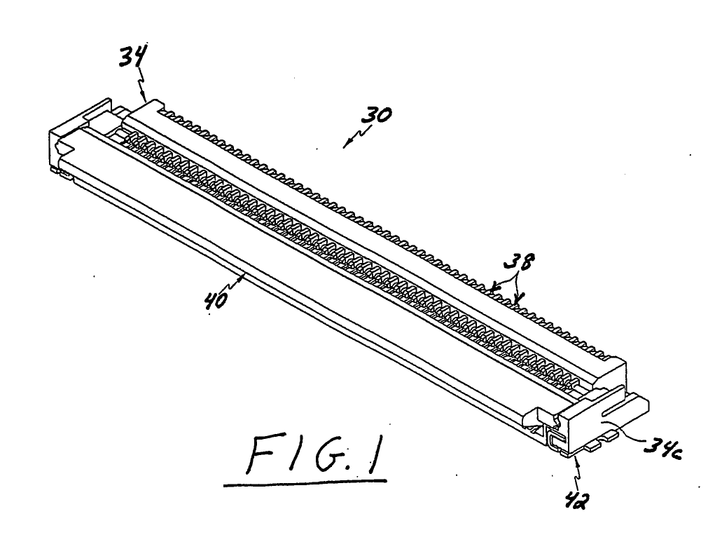

Referring to the drawings in greater detail, and first to FIGS. 1-3. the invention is embodied in an electrical connector, generally designated 30, for connecting a flat electrical circuit 32 (not shown) to a printed circuit board (not shown). The flat electrical circuit may include flat cables or circuits, flat flexible cables, flexible printed circuits or the like.

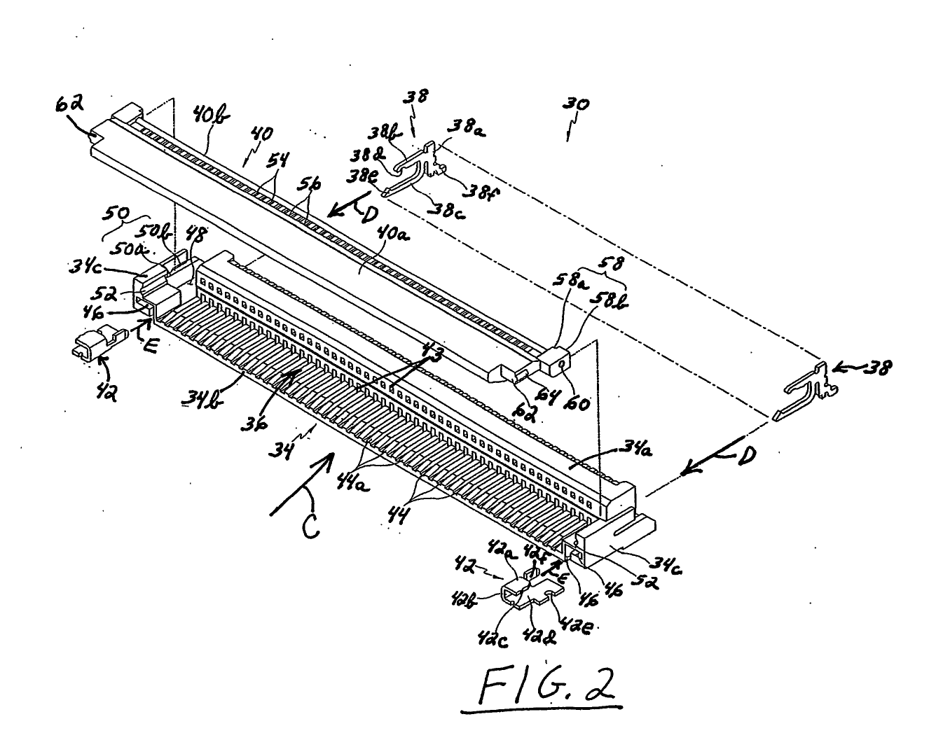

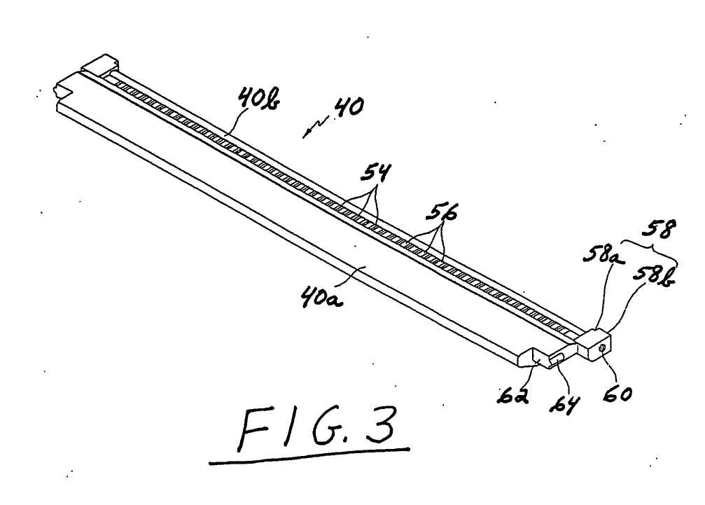

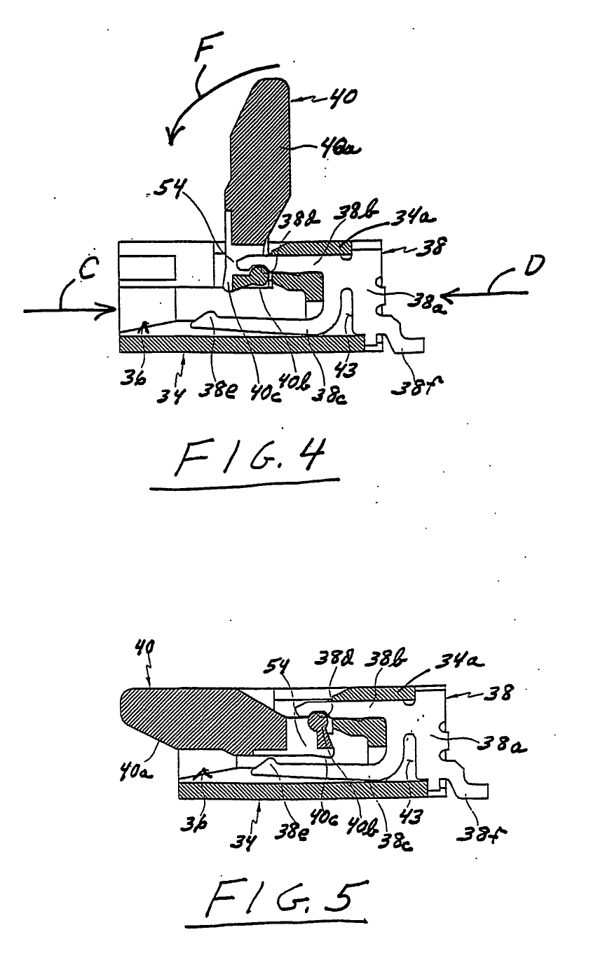

Connector 10 includes a dielectric housing, generally designated 34, which is elongated and may be molded of plastic material. The housing defines a slot, generally designated 36, at the front end of the housing for receiving an end of the flat circuit in a circuit insertion direction as indicated by arrow “C” in FIG. 2. A plurality of conductive terminals, generally designated 38, are mounted in housing 34 in a side-by-side array and spaced along slot 36. Only the two end-most terminals are shown in FIG. 2. An actuator, generally designated 40, is pivotally mounted on housing 34 for movement between an open position (FIG. 3) allowing the flat circuit to be inserted into slot 36 and a closed position (FIG. 4) biasing the flat circuit against the terminals, as will be seen hereinafter. The terminals are inserted into the rear of the housing in the direction of arrows “D” and a pair of fitting nails, generally designated 42, are inserted into the front of the housing in the direction of arrows “E”.

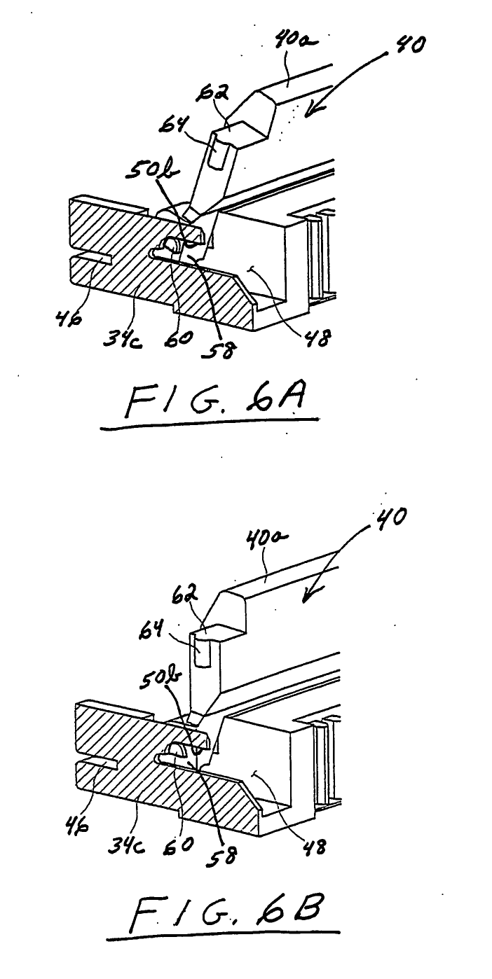

Referring to FIGS. 4 and 5 in conjunction with FIG. 2, terminals 38 are inserted into terminal-receiving passages 43 in housing 34. Each terminal includes a generally horizontally oriented, U-shaped configuration defined by a base, 38a, an upper pivot arm 38b and a lower contact arm 38c. The upper pivot arm has a pivot groove 38d formed in the underside thereof near the distal end thereof. The contact arm has a contact portion 38e at the distal end thereof projecting into the circuit-receiving slot 36. A foot 38f projects downwardly from base 38a and is disposed generally flush with the bottom of housing 34 for connection to an appropriate circuit trace on the printed circuit board. The terminals are stamped and formed of conductive sheet metal material.

Housing 34 is elongated and includes an upstanding rear portion 34a and a bottom, forwardly projecting platform portion 34b whereby the circuit-receiving slot 36 is open in an upward and forward direction. A plurality of generally parallel guide grooves 44 are spaced along platform portion 34b between a plurality of partitions 44a. When terminals 38 are inserted into the housing, contact arms 38c are guided into grooves 44, with the contact portions 38e projecting upwardly into the circuit-receiving slot 36.

A pair of end walls 34c are formed integrally with housing 34. Fitting nails 42 are inserted in the direction of arrows “E” into a pair of inverted L-shaped nail-receiving passages 46 formed in the pair of end walls and opening at the front of the housing. An upwardly opening actuator-receiving slot 48 is formed in each end wall 34c at the rear thereof behind and in communication with the respective nail-receiving passage 46. A rotating cam groove or recess 50 is formed inside each end wall 34c within slot 48. The cam-receiving groove 50 includes a first cam groove or recess 50a and a second cam groove or recess 50b above the first groove, for purposes described hereinafter. A locking groove 52 is formed on the inside of each end wall 34c above the respective nail-receiving passage 46.

Actuator 40 is elongated and includes an elongated pressure plate 40a along the front thereof and an elongated pivot shaft 40b along the rear thereof spaced from the pressure plate. The actuator is a one-piece structure, and pivot shaft 40b is connected to pressure plate 40a by a plurality of supports 54 at spaced intervals along the length of the actuator, and defining spaces 56 between the supports. A rounded pressing portion 40c is formed at the bottom rear corner of the actuator.

Actuator 40 further includes a block-like support boss 58 at each opposite end thereof. A rotating cam 60 projects outwardly from the outer surface of boss 58. Boss 58 has a support 58a and a movement prevention portion 58b, for purposes described hereinafter. Pressure plate 40a of actuator 40 includes a cut-out 62 at each corner thereof. Finally, a locking protrusion 64 projects outwardly from each opposite end of pressure plate 40a.

Each fitting nail 42 includes an L-shaped mounting portion 42a defined by a vertical or upright support plate 42b and a horizontal support plate 42c. The L-shaped mounting portion is insertable into the respective L-shaped passage 46 at the front of the respective end wall 34c of the housing. The fitting nail has a horizontal fixing plate or foot 42d at the bottom thereof and which will be generally flush with housing 34 for connection, as by soldering, to a mounting pad on the printed circuit board to fix the connector to the board. An open-sided hole 42e is formed in the outer edge of fixing plate 42d for receiving a fixing member (not shown) to further fix the connector to the board. According to the invention, each fitting nail 42 includes a biasing portion or elevating arm 42f in the form of a vertical plate for biasing actuator 40 upwardly and securely seat pivot shaft 40b of the actuator into pivot grooves 38d of terminals 38. In essence, plate 42f vertically supports the actuator, particularly in its closed position.

FIG. 4 shows actuator 40 in an upright or open position so that an end of a flat circuit can be inserted freely into slot 36 in the direction of arrow “C”. It can be seen that pivot shaft 40b is seated in pivot grooves 38d in the underside of pivot arms 38b of terminals 38. After the flat circuit is inserted into space 36, actuator 40 is pivoted downwardly in the direction of arrow “F” to its closed position shown in FIG. 5. In this position, pressure plate 40a of the actuator will press the flat circuit against contact portions 38e of contact arms 38c of the terminals.

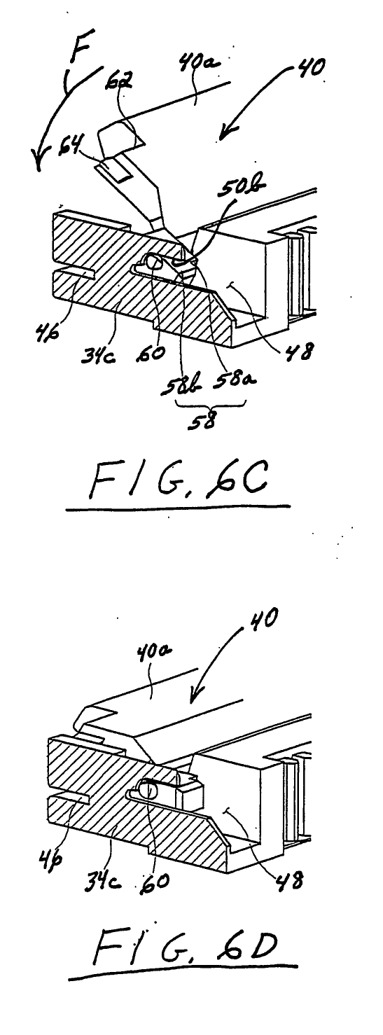

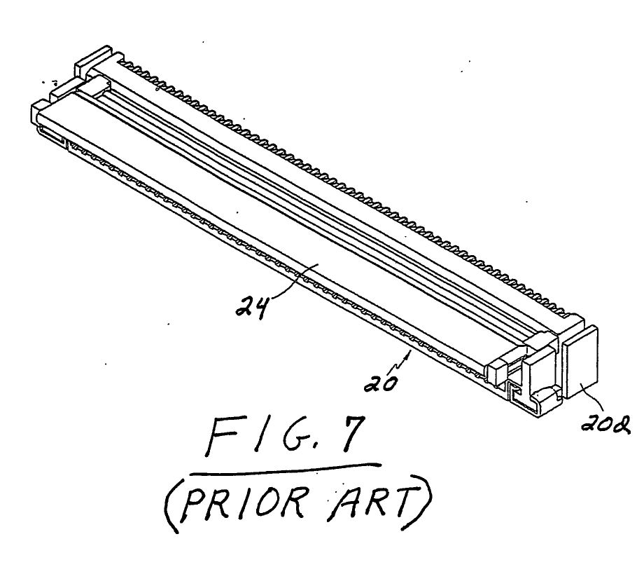

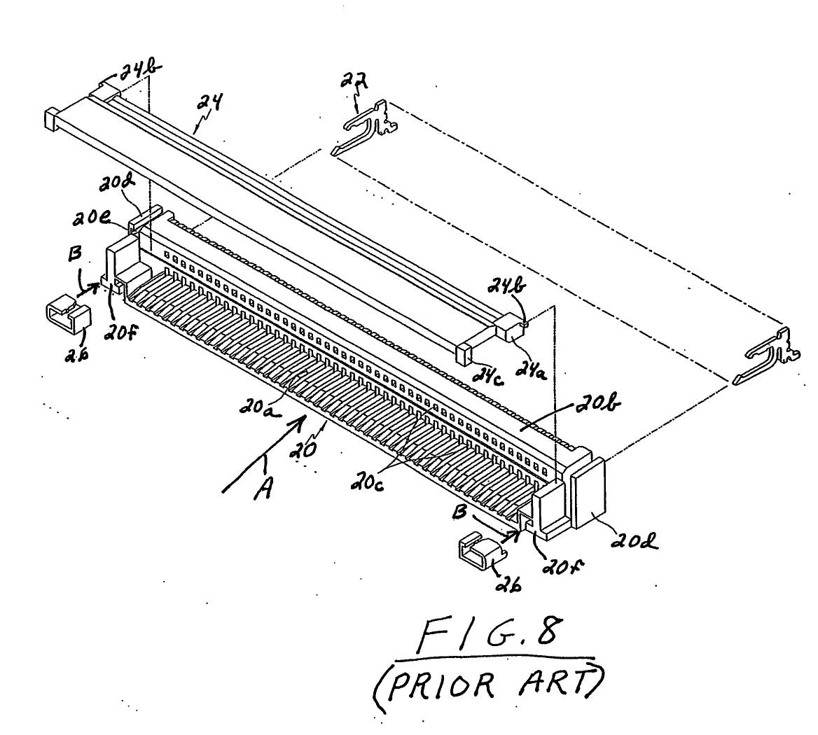

FIGS. 6A-6D also show sequential depictions of actuator 40 being pivoted from its open position (FIGS. 6A and 6B) in the direction of arrow “F” (FIG. 6C) to its closed position (FIG. 6D). It can be seen that support boss 58 of the actuator is positioned within the actuator-receiving slot 48 in end wall 34c of the housing. Cam projection 60 is located in cam groove 50b. When the actuator is rotated to its closed position, locking projection 64 snaps into locking groove 52 (see FIG. 2) in the inside of end wall 34c.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical connector (30) for terminating a flat electrical circuit, comprising.
a dielectric housing (34) having a front opening (36) for receiving an end of the flat circuit;
a plurality of terminals (38) mounted on the housing in a side-by-side array and spaced laterally along the opening, and
an elongated actuator (40) movably mounted on the housing for movement between an open position allowing the flat circuit to be inserted into said opening and a closed position and including
an elongated pressing plate (40a) along a front of the actuator for biasing the fat circuit against said terminals when the actuator is in its closed position,
an elongated pivot shaft (40b) along a rear of the actuator and spaced from the pressing plate for pivoting the actuator between said open and closed positions,
a plurality of supports (54) spaced longitudinally of the actuator and joined between the elongated pressing plate and the elongated pivot shaft; and
longitudinally outwardly projecting locking protrusions (64) with a rounded edge at opposite ends thereof and positionable in locking grooves (52) at opposite ends of the housing (34) when the actuator is in its closed position.

2. The electrical connector of claim 1 wherein at least some of said terminals (38) comprise pivot terminals having pivot means (38d) for engaging the pivot shaft (40b) of the actuator (40) to facilitate pivot movement of the actuator.

3. The electrical connector of claim 1 wherein said terminals (38) include portions (38b) located between said supports (54) spaced longitudinally of the actuator (40).

4. The electrical connector of claim 1 wherein said actuator (40) includes longitudinally outwardly projecting arms (60) at opposite ends thereof and rotatably positioned in cam recesses (50) in the housing (34).

5. The electrical connector of claim 1 wherein, when the actuator (40) is in its closed position, the pressing plate (40a) is forwardly of a vertical plane passing through the pivot shaft (40b), and the actuator includes a pressure portion (40c) rearwardly of said plane for performing a dual function of (a) pressing the flat circuit against the terminals (38), and (b) providing an over-center means to resist rotation of the actuator (40) away from its closed position.

6. An electrical connector (30) for terminating a flat electrical circuit, comprising:
a dielectric housing (34) having a front opening (36) for receiving an end of the flat circuit;
a plurality of terminals (38) mounted on the housing in a side-by-side array and spaced laterally along the opening, at least some of the terminals comprising pivot terminals having pivot arms (38b);
an elongated actuator (40) pivotally mounted on the housing for movement between an open position allowing the flat circuit to be inserted into said opening and a closed position and including
an elongated pressing plate (40a) along a front of the actuator for biasing the flat circuit against said terminals when the actuator is in its closed position,
an elongated pivot shaft (40b) along a rear of the actuator and spaced from the pressing plate for pivoting the actuator between said open and closed positions,
a plurality of supports (54) spaced longitudinally of the actuator and joined between the elongated pressing plate and the elongated pivot shaft with spaces deemed between the supports, and
longitudinally outwardly projecting locking protrusions (64) with a rounded edge at opposite ends thereof and positionable in locking grooves (52) at opposite ends of the housing (34) when the actuator is in its closed position; and.
said pivot arms (38b) of the pivot terminals being aligned with said spaces between said supports spaced longitudinally of the actuator.

7. The electrical connector of claim 7 wherein said actuator (40) includes longitudinally outwardly projecting cams (60) at opposite ends thereof and rotatably positioned in cam recesses (50) in the housing (34).

8. The electrical connector of claim 7 wherein said pivot terminals (38) include said pivot arms (38b) with pivot means (38d) thereon engageable with the pivot shaft (40b), contact arms (38c) extending into said opening for engaging appropriate contacts on the flat circuit, and feet portions (38f) for connection to appropriate circuit traces on a printed circuit board.

9. The electrical connector of claim 10 wherein the pivot arms (38b) of said pivot terminals (38) are located above said opening (36), and including at least one fitting nail (42) mounted on the housing (34) for fixing the housing to the printed circuit board, the fitting nail having elevating means (42f) for biasing the pivot shaft of the actuator into engagement with the pivot means of the pivot arms.

10. The electrical connector of claim 7 wherein, when the actuator (40) is in its closed position, the pressing plate (40a) is forwardly of a vertical plane passing through the pivot shaft (40b), and the actuator includes a pressure portion (40c) rearwardly of said plane for performing a dual function of (a) pressing the flat circuit against the terminals (38), and (b) providing an over-center means to resist rotation of the actuator (40) away from its closed position.
